(19) United States
(12) Patent Application Publication
(10) Pub. No.: US 2019/0234353 A1
(43) Pub. Date: Aug. 1, 2019

(54) ENGINE INTAKE AND EXHAUST SYSTEM

(71) Applicant: Mazda Motor Corporation, Aki-gun (JP)

(72) Inventors: Hisayoshi Yamada, Hiroshima-shi (JP); Yuji Kojima, Hiroshima-shi (JP); Kazuhiro Tokushima, Hiroshima-shi (JP)

(21) Appl. No.: 16/244,032

(22) Filed: Jan. 9, 2019

(30) Foreign Application Priority Data
Jan. 26, 2018 (JP) 2018-011173

(51) Int. Cl. F02M 26/50; F02M 26/23; F01N 13/08; F02M 26/41

(52) U.S. Cl. CPC F02M 26/50; F02M 26/41; F01N 13/08; F02M 26/23

(57) ABSTRACT

An intake and exhaust system of an engine mounted on a vehicle is provided, which includes an exhaust passage, an intake passage disposed above the exhaust passage in up-and-down directions of the vehicle, and an exhaust gas recirculation (EGR) passage extending in the up-and-down directions and communicating the exhaust passage to the intake passage, the EGR passage including an EGR cooler, an EGR valve disposed downstream of the EGR cooler in a flow direction of EGR gas, and a connecting passage, disposed between the EGR cooler and the EGR valve, that connects the EGR cooler to the EGR valve in a separated state from each other in the flow direction.

### TECHNICAL FIELD

The present disclosure relates to an engine intake and exhaust system, which includes an exhaust gas recirculation (EGR) system which recirculates a portion of exhaust gas to an intake passage.

### BACKGROUND OF THE DISCLOSURE

To prevent an excessive temperature increase in combustion gas and generation of nitrogen oxide and to reduce a pumping loss during an intake process, engines provided with an EGR passage which recirculates a portion of exhaust gas to an intake passage are known. WO2013/054711A1 discloses one example of a structure of such an engine, in which an EGR passage extending in up-and-down directions of the engine connects an intake passage to an exhaust passage disposed therebelow.

This EGR passage includes an upstream EGR pipe having a lower end part (an upstream end part in EGR gas flow directions) connected to the exhaust passage, extending in the up-and-down directions, an EGR cooler connected to an upstream end part of the upstream EGR pipe, an EGR valve connected to an outlet portion of the EGR cooler, and a downstream EGR pipe connecting the EGR valve to the intake passage (intake manifold). That is, the exhaust gas (EGR gas) led out from the exhaust passage through the upstream EGR pipe is guided toward the intake side, cooled by the EGR cooler, and then is introduced into the intake passage through the downstream EGR pipe while its flow rate is adjusted by the EGR valve.

In the EGR system of WO2013/054711A1, condensed water generated inside the EGR passage (i.e., water component within EGR gas condensed by the EGR cooler) does not flow into the intake passage but flows back into the exhaust passage. Therefore, the condensed water is purified by a purifying device disposed in the exhaust passage, before being discharged outside. However, a portion of the condensed water may adhere to the EGR valve or accumulate on the downstream side of the EGR valve. In such circumstance, especially under a certain cold climate condition, the condensed water may freeze and induce valve malfunction. Therefore, an improvement is required to avoid this from occurring.

### SUMMARY OF THE DISCLOSURE

The present disclosure is made in view of the above situations and aims to prevent, in an engine intake and exhaust system including an EGR valve, malfunction of the EGR valve caused by condensed water adhering, etc. to the EGR valve.

According to one aspect of the present disclosure, an intake and exhaust system of an engine mounted on a vehicle is provided, which includes an exhaust passage, an intake passage disposed on an upper side of the exhaust passage in up-and-down directions of the vehicle, and an exhaust gas recirculation (EGR) passage extending in the up-and-down directions and communicating the exhaust passage to the intake passage. The EGR passage includes an EGR cooler, an EGR valve disposed downstream of the EGR cooler in a flow direction of EGR gas, and a connecting passage, disposed between the EGR cooler and the EGR valve, that connects the EGR cooler to the EGR valve in a separated state from each other in the flow direction.

According to this structure, since the EGR valve and the EGR cooler are disposed in the separated state and the connecting passage is disposed therebetween, even if condensed water is generated in the EGR gas after passing through the EGR cooler, it is possible to let the condensed water flow along the connecting passage. Thus, condensed water generated after passing through the EGR cooler adhering to the EGR valve, etc., is prevented.

In this case, the connecting passage may extend upwardly from the EGR cooler and curve at an intermediate location without curving below a horizontal plane.

According to this structure, the condensed water in the EGR gas can flow along the connecting passage while being separated from the EGR gas by colliding against a wall surface of the curve. Thus, this structure is advantageous in preventing the condensed water from adhering to the EGR valve. Additionally, since the connecting passage curves without curving below the horizontal plane, no inconvenience, such as the condensed water accumulating in the curve, occurs.

The EGR valve may be provided in a downstream end part of the EGR passage in the flow direction of the EGR gas.

According to this structure, the EGR valve is disposed as far as possible from the EGR cooler. Thus, the length of the connecting passage, i.e., a section where the condensed water generated after passing through the EGR cooler to flow, can be made longer, which is advantageous in preventing adhesion of the condensed water to the EGR valve. In addition, since the part of the EGR passage downstream of the EGR valve is shortened as much as possible, the condensed water generated in the intake passage is prevented from accumulating in this part (downstream of the EGR valve), or only a small amount is accumulated.

The EGR cooler may be provided in an upstream end part of the EGR passage in the flow direction of the EGR gas and may be directly connected to the exhaust passage.

According to this structure, the EGR cooler is disposed as far as possible from the EGR valve. Thus, the length of the connecting passage, i.e., the section where the condensed water generated after passing through the EGR cooler flows, can be made longer, which is advantageous in preventing the condensed water from adhering to the EGR valve. In addition, since the EGR cooler is disposed at the closest possible position to the exhaust passage, it becomes possible to swiftly introduce the condensed water generated in the EGR cooler into the exhaust passage.

The EGR cooler may be arranged so that the EGR gas flows upwardly.

According to this structure, the condensed water generated in the EGR cooler is swiftly introduced into the exhaust passage.

### BRIEF DESCRIPTION OF THE DRAWINGS

FIG. 1 is a diagram illustrating a schematic structure of an engine.

FIG. 2 is a side view of the engine (a view seen in a direction II of FIG. 3).

FIG. 3 is a plan view of the engine.

FIG. 4 is an enlarged view of a main part of FIG. 2.

FIG. 5 is another side view of the engine (a view seen in a direction V of FIG. 2).

FIG. 6 is a cross-sectional view of an upstream intake passage (mainly an inclining part).

FIG. 7 is another side view of the engine (a view seen in a direction VII of FIG. 2).

FIG. 8 is an enlarged side view of a main part of the engine (a view seen in a direction VIII of FIG. 3).

FIG. 9 is a plan view of a downstream exhaust passage (a part around a branch part).

### DETAILED DESCRIPTION OF THE DISCLOSURE

Hereinafter, one embodiment of the present disclosure is described with reference to the accompanying drawings.

[Schematic Structure of Engine]

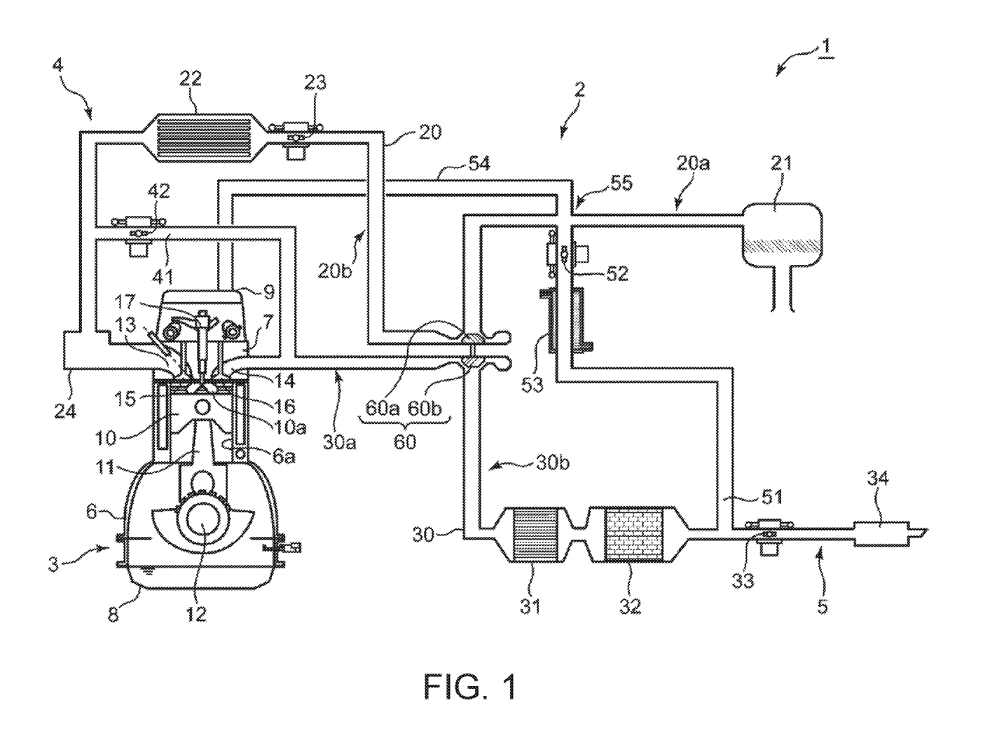

FIG. 1 is a diagram illustrating a schematic structure of an engine 2 according to this embodiment. The engine 2 is mounted on a vehicle 1. In this embodiment, the vehicle 1 is an automobile. The engine 2 is an inline multi-cylinder diesel engine and includes an engine body 3, an intake system 4, and an exhaust system 5. The intake and exhaust systems 4 and 5 of this embodiment may be referred to as the intake and exhaust system.

The engine body 3 includes a cylinder block 6 formed with a plurality of cylinders 6a (only one cylinder 6a is illustrated in FIG. 1), a cylinder head 7 mounted on the cylinder block 6, an oil pan 8 disposed below the cylinder block 6, and a head cover 9 covering the cylinder head 7.

Each of the plurality of cylinders 6a formed in the cylinder block 6 accommodates a piston 10 reciprocatable in up-and-down directions of the engine. A top surface of the piston 10 forms one of surfaces defining a combustion chamber 10a in the engine body 3.

The piston 10 is connected to a connecting rod 11 extending downwardly. A crankshaft 12 is pivotably supported by a lower end of the connecting rod 11 to be rotatable in conjunction with the reciprocation of the piston 10.

The cylinder head 7 is formed with an intake port 13 and an exhaust port 14 opening to each combustion chamber 10a. An intake valve 15 is disposed at an opening section of the intake port 13 to communicate this section to the combustion chamber 10a, and an exhaust valve 16 is disposed in an opening section of the exhaust port 14 to communicate this section to the combustion chamber 10a.

Further, an injector 17 which injects fuel into the combustion chamber 10a is disposed in the cylinder head 7 for each cylinder 6a. The injector 17 is arranged such that its nozzle port (fuel injection port) faces the top surface of the piston 10.

The intake system 4 has an intake passage 20 connected to the intake port 13 of the engine body 3. A compressor 60a of a turbocharger 60 (may be referred to as “booster”) is disposed in the intake passage 20. The intake passage 20 includes an upstream intake passage 20a located upstream of the compressor 60a and a downstream intake passage 20b located downstream of the same, in a flow direction of intake air (air).

Note that in the description of the intake passage 20, “upstream (side)” and “downstream (side)” are defined based on the flow direction of air (intake air) unless otherwise specified. Similarly, for description of an exhaust passage 30, EGR passages 41 and 51 and a blow-by gas passage 54 given later, “upstream (side)” and “downstream (side)” are defined based on a flow direction of gas inside each passage unless otherwise specified.

A throttle valve 23, an intercooler 22, and a surge tank 24 are provided in the downstream intake passage 20b. The intercooler 22 is provided to cool the air compressed by the compressor 60a of the turbocharger 60.

The throttle valve 23 adjusts an amount of air supplied to the combustion chamber 10a through the intake passage 20. Note that in this embodiment, the throttle valve 23 is basically controlled to be fully opened or close to fully opened during operation of the engine 2, and is closed only when necessary, such as when the engine 2 is stopped.

The surge tank 24 is provided at a position immediately upstream of a connecting portion of the intake passage 20 with the intake port 13, to level an air flow rate into the plurality of combustion chambers 10a.

The exhaust system 5 has the exhaust passage 30 connected to the exhaust port 14 of the engine body 3. A turbine 60b of the turbocharger 60 is interposed in the exhaust passage 30. During operation of the engine 2, the turbine 60b rotates by the exhaust gas discharged from the engine body 3, and the compressor 60a connected to the turbine 60b rotates together with the turbine 60b to compress the air in the intake passage 20.

The exhaust passage 30 includes an upstream exhaust passage 30a located upstream of the turbine 60b of the turbocharger 60 and a downstream exhaust passage 30b located downstream of the same.

A DOC (Diesel Oxidation Catalyst) 31, a DPF (Diesel Particulate Filter) 32, an exhaust shutter valve 33, and a silencer 34 are provided in the downstream exhaust passage 30b. The DOC 31 detoxifies CO and HC within the exhaust gas discharged from the engine body 3 by oxidizing them, and the DPF 32 collects fine particles (e.g., soot) contained within the exhaust gas.

The exhaust shutter valve 33 is provided between the DPF 32 and the silencer 34 in the downstream exhaust passage 30b and controls a flow rate of the exhaust gas discharged outside through the silencer 34.

The engine 2 is also provided with the HP-EGR (High Pressure-Exhaust Gas Recirculation) passage 41, the LP-EGR (Low Pressure-Exhaust Gas Recirculation) passage 51, and the blow-by gas passage 54.

The HP-EGR passage 41 is provided to connect the upstream exhaust passage 30a to the downstream intake passage 20b. For example, the HP-EGR passage 41 is provided to connect a position of the upstream exhaust passage 30a immediately downstream of a connecting point with the exhaust port 14 and on the upstream side of the turbine 60b, to a position of the downstream intake passage 20b between the intercooler 22 and the surge tank 24. The HP-EGR passage 41 recirculates a portion of high-pressure exhaust gas discharged from the combustion chamber 10a to the downstream intake passage 20b. The HP-EGR passage 41 is provided with an EGR valve 42 which adjusts the amount of exhaust gas recirculated to the downstream intake passage 20b.

The LP-EGR passage 51 is provided to connect the downstream exhaust passage 30b with the upstream intake passage 20a. For example, the LP-EGR passage 51 is provided to connect a position of the downstream exhaust passage 30b between the DPF 32 and the exhaust shutter valve 33, with a position of the upstream intake passage 20a between an air cleaner 21 and the compressor 60a.

The LP-EGR passage 51 may be referred to as the “EGR passage.” An EGR valve 52 and an EGR cooler 53 are provided in this LP-EGR passage 51. The exhaust gas passing through the LP-EGR passage 51 is cooled by the EGR cooler 53 and then recirculated to the upstream intake passage 20a according to an opening of the EGR valve 52.

The blow-by gas passage 54 returns the blow-by gas generated in the engine body 3 to the upstream intake passage 20a and is provided to connect the head cover 9 of the engine body 3 with the upstream intake passage 20a. The blow-by gas returned to the upstream intake passage 20a is mixed with fresh air (air) and sent to the combustion chamber 10a.

Although not clearly illustrated in FIG. 1, the blow-by gas passage 54 is connected to the upstream intake passage 20a at a position 55 immediately upstream of the turbocharger 60 (compressor 60a).

### [Specific Structure of Engine]

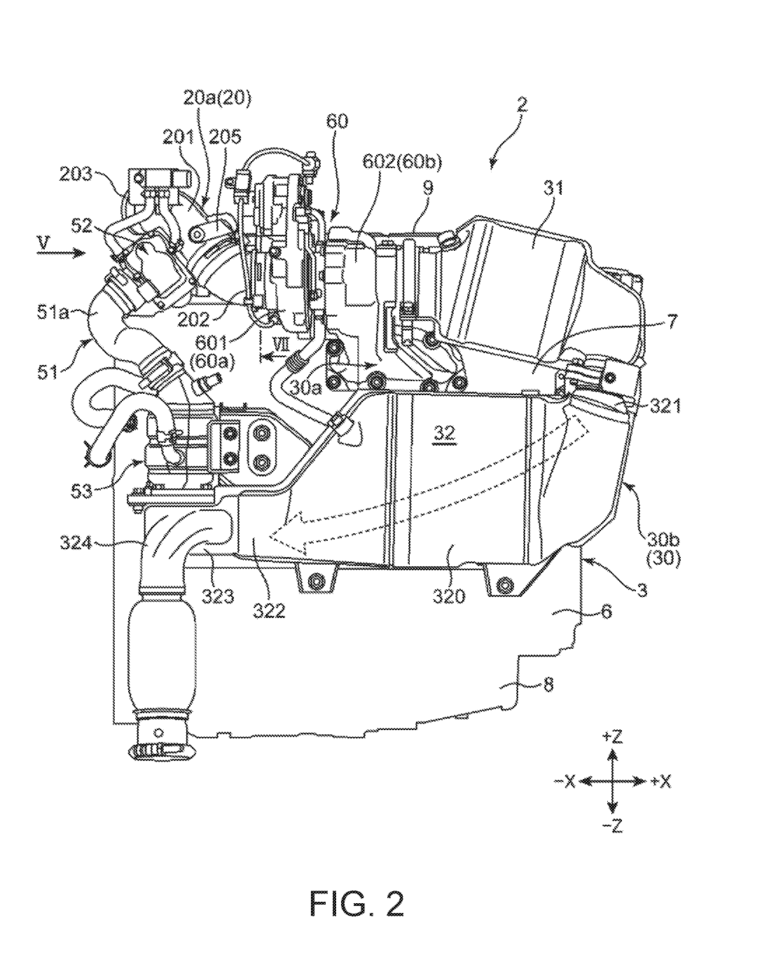

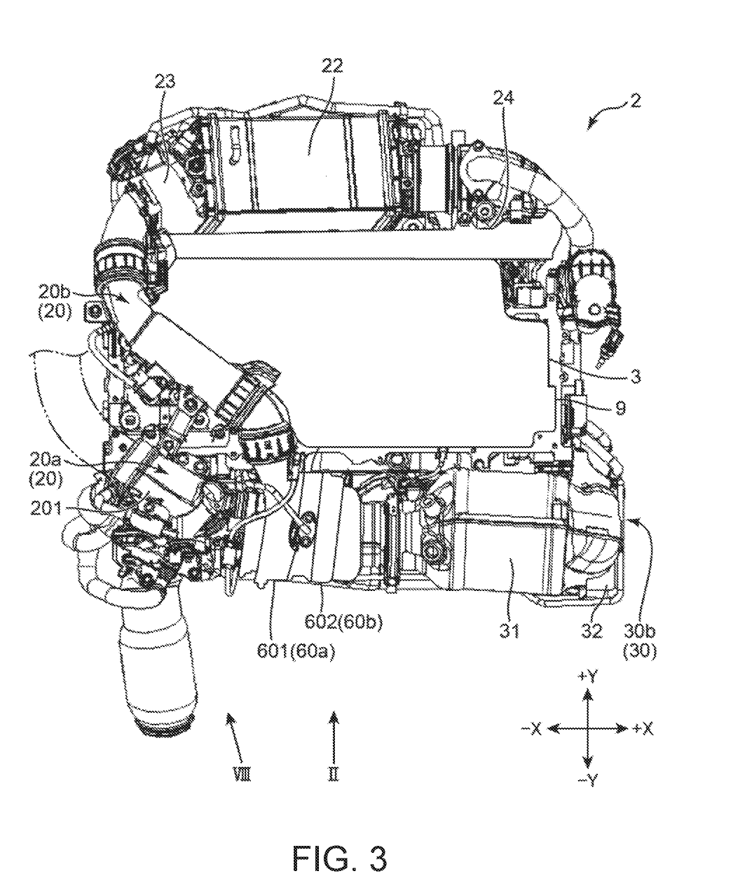

Next, the more specific structure of the engine 2 will be described. FIG. 2 is a side view of the engine 2 (a view seen in the direction II of FIG. 3), and FIG. 3 is a plan view of the engine 2.

In FIG. 2 and subsequent drawings, an X, Y, Z orthogonal coordinate system is illustrated to clarify directions. In this embodiment, the engine 2 is mounted on the vehicle 1 with the axial direction of the cylinder 6a coinciding with up-and-down directions of the vehicle 1. Therefore, the Z directions coincide with the up-and-down directions of the vehicle 1 and the engine 2 (e.g., vertical directions), and the X directions coincide with a lined-up direction of the cylinders 6a in the engine 2. Further, the Y directions coincide with width directions of the engine 2 (e.g., horizontal directions), the −Y side is the exhaust side of the engine 2 (the side where the exhaust port 14 is formed), the +Y side is the intake side of the engine 2 (the side where the intake port 13 is formed).

As illustrated in FIGS. 2 and 3, the exhaust system 5 is disposed on a −Y side surface of the engine body 3. For example, the turbocharger 60 is disposed at a position on the −Y side surface of the engine body 3, near an end part of a +Z side of a center part in the X directions. The turbocharger 60 is arranged so that a connecting shaft (not illustrated) between the turbine 60b and the compressor 60a extends in the X directions i.e., horizontally, the turbine 60b is located on the +X side and the compressor 60a is on the −X side with respect to each other. A reference character 601 in FIG. 2 indicates a compressor housing accommodating the compressor 60a, and a reference character 602 indicates a turbine housing accommodating the turbine 60b.

An upstream end part of the downstream exhaust passage 30b is connected to the turbocharger 60 (compressor housing 601). The downstream exhaust passage 30b is disposed to extend to the +X side along the −Y side surface of the engine body 3 and be inverted by 180° at an end part of the engine body 3 on the +X side (hereinafter, “the end part of the X/Y/Z side” may simply referred to as “the X/Y/Z end part”). Specifically, the DOC 31 is disposed adjacent to the +X side of the turbocharger 60, and the DPF 32 is disposed adjacent to the −Z side of the turbocharger 60 and the DOC 31. The DOC 31 and the DPF 32 are directly connected to each other at the +X end part of the engine body 3.

The DPF 32 extends in the X directions and is disposed over an area from a +X end part of the DOC 31 to a −X end part of the turbocharger 60. The DPF 32 has a rectangular main body part 320, an exhaust gas inlet part 321 located its end part at the +X and +Z sides, and an exhaust gas outlet part 322 located at an end part of the main body part 320 at the −X and −Z sides. The inlet part 321 has a through-hole substantially in the Z directions and introduces the exhaust gas in the −Z direction. The outlet part 322 has a tubular shape extending from an end portion of the main body part 320 to the −X side and has a penetrating opening in the X directions. Thus, the exhaust gas is led out in the −X direction. With this configuration, in the DPF 32, as indicated by a dashed arrow in FIG. 2, a main stream of the exhaust gas flows obliquely from the upstream side to the downstream side of the DPF 32, flows along a −Z side inner surface (inner bottom surface) of the DPF 32, and is finally led out from the outlet part 322.

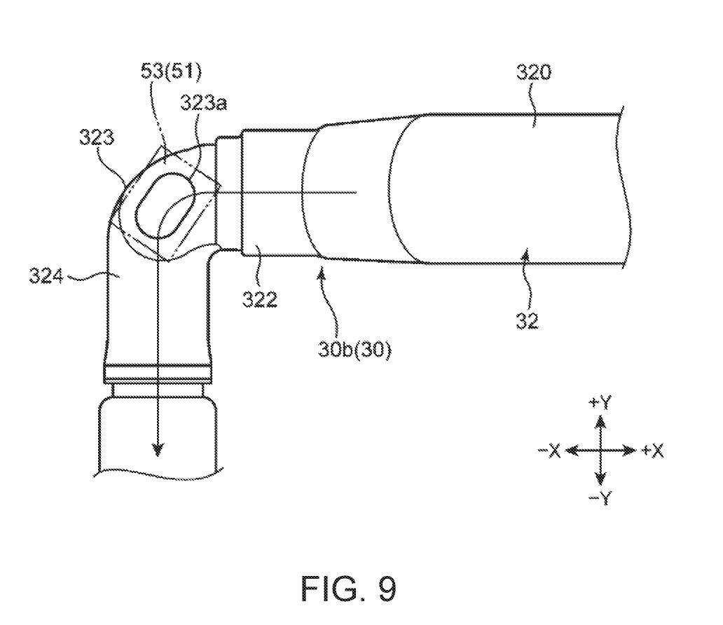

The downstream exhaust passage 30b includes a branch part 323 connected to the outlet part 322 of the DPF 32 that branches a channel of the exhaust gas in the up-and-down directions, and a guide part 324 connected to the branch part 323 that guides the exhaust gas from the branch part 323 to the −Y side as well as the −Z side. As described later, an upstream end part of the LP-EGR passage 51 is connected to a +Z side surface (upper surface) of the branch part 323. That is, the downstream exhaust passage 30b curves by about 90° on the downstream side of the DPF 32 (see FIG. 9), and this curve forms the branch part 323. In this branch part 323, the channel of the exhaust gas is branched into the guide part 324 and the LP-EGR passage 51. Note that in FIGS. 2 and 3, the silencer 34 is omitted.

As illustrated in FIG. 3, the throttle valve 23, the intercooler 22 and the surge tank 24 of the downstream intake passage 20b are arranged along the +Y side surface of the engine body 3. Further, a part of the downstream intake passage 20b downstream of the throttle valve 23 is disposed to pass through the +Z end surface of the engine main body 3, and an upstream end part of the downstream intake air passage 20b is connected to the turbocharger 60 (compressor housing 601).

The upstream intake passage 20a is disposed on the −X side of the downstream intake passage 20b, on the +Z end surface of the engine body 3. A downstream end part of the upstream intake passage 20a is connected to the turbocharger 60 (the compressor housing 601).

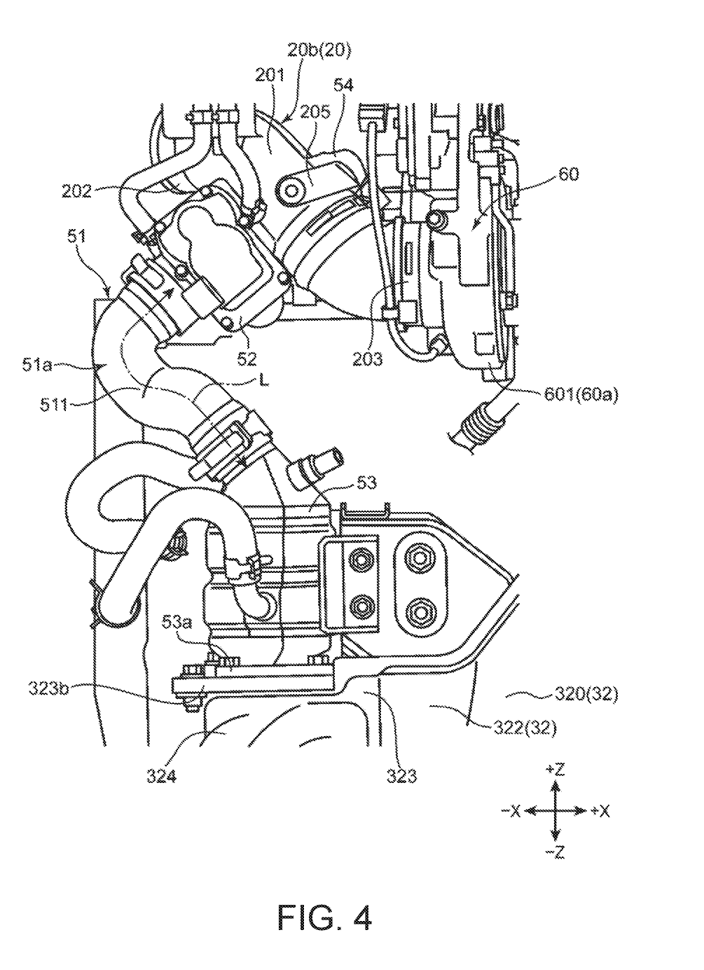

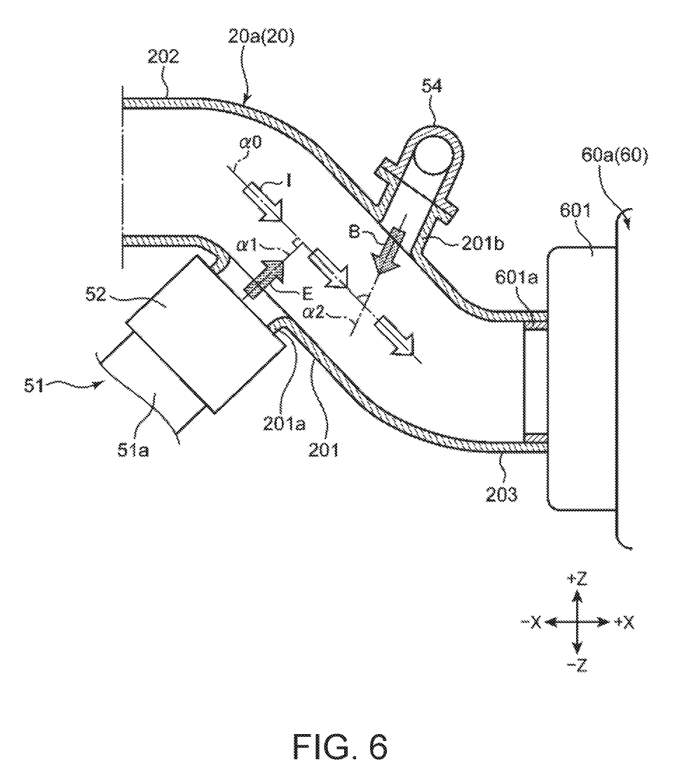

As illustrated in FIGS. 2 and 4, the upstream intake passage 20a is provided in its part immediately upstream (−X side) of the connecting point with the turbocharger 60, with an inclining part 201 extending from the upstream to downstream side (−X side to +X side) while shifting to the −Z side, i.e., inclined obliquely downwardly. On the upstream side and the downstream side of the inclining part 201, horizontal parts 202 and 203 extending horizontally (the upstream horizontal part 202 and the downstream horizontal part 203) are continuously provided, respectively. The downstream horizontal part 203 is connected to a cylindrical suction port 601a (see FIG. 6) projecting from a side surface (a −X side surface) of the compressor housing 601. Thus, the upstream intake passage 20a is connected to the turbocharger 60.

As illustrated in FIG. 2, the inclining part 201 of the upstream intake passage 20a and the branch part 323 of the downstream intake passage 20b are opposed to each other substantially in the Z directions. Further, the LP-EGR passage 51 is disposed along the −Y side surface of the engine body 3, and the inclining part 201 is communicated to the branch part 323 by the LP-EGR passage 51.

As illustrated in FIG. 4, the LP-EGR passage 51 extends in the Z directions, and a downstream end part thereof in the flow direction of the EGR gas is connected to a −Z side surface (lower portion) of the inclining part 201, while an upstream end part is connected to a +Z side surface (upper portion) of the branch part 323. More specifically, the LP-EGR passage 51 has the EGR valve 52 at its downstream end part and the EGR cooler 53 at its upstream end part. The EGR valve 52 is directly connected to the −Z side surface of the inclining part 201, and the EGR cooler 53 is directly connected to the +Z side surface of the branch part 323.

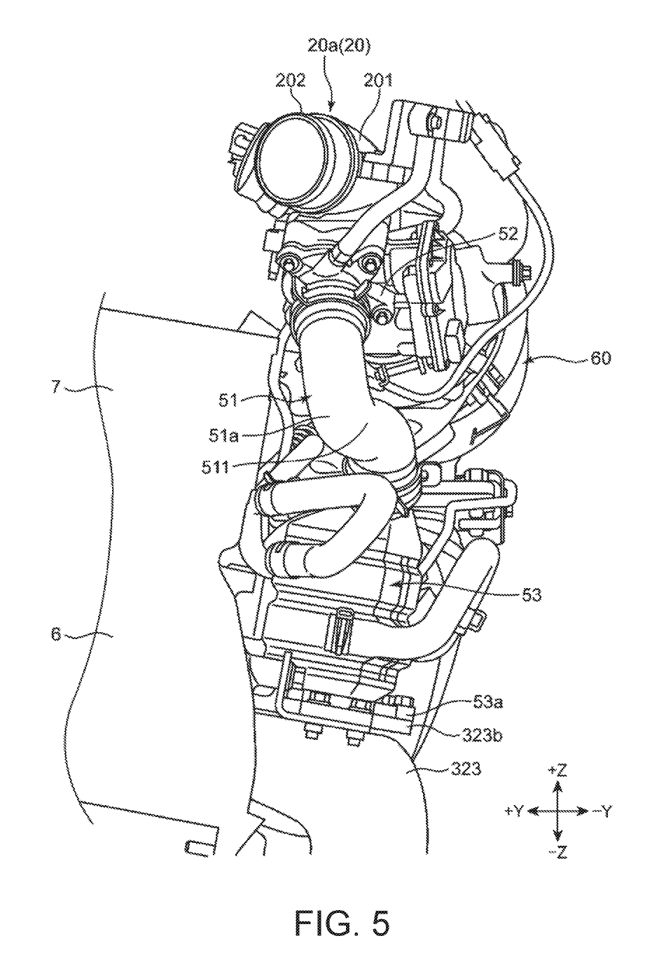

A part of the LP-EGR passage 51 between the EGR valve 52 and the EGR cooler 53, that is, a part connecting the EGR valve 52 to the EGR cooler 53 (referred to as a connecting passage 51a) is structured by an elastic pipe member. As illustrated in FIGS. 4 and 5, the connecting passage 51a extends from the EGR cooler 53 to the +Z side and curves (a curved portion 511) at an intermediate position thereof. As a result, a length L of the connecting passage 51a is longer than a case where the EGR valve 52 and the EGR cooler 53 are connected linearly. Note that the curved portion 511 curves without curving below the horizontal plane. In other words, the curved portion 511 has a shape in which the downstream side is located on the +Z side of (higher than) the upstream side thereof. Note that the definition of “curve” used here includes a gentle curve, a sharp curve, and a bend.

As illustrated in FIG. 6, a tube-shaped first port portion 201a is provided to project from the −Z side surface of the upstream end section of the inclining part 201 of the upstream intake passage 20a. The EGR valve 52 is connected to the first port portion 201a. The first port portion 201a is provided so that its axis (center axis) α1 intersects an axis α0 of the inclining part 201 at a substantially right angle. As a result, the EGR gas (an arrow E in FIG. 6) mixes with air flowing through the inclining part 201 (an arrow I in FIG. 6) at a substantially right angle.

Further, a tube-shaped second port portion 201b is provided to project from the +Z side surface of the inclining part 201, at a position between the first port portion 201a and the turbocharger 60 in the inclining part 201. The blow-by gas passage 54 is connected to the second port portion 201b. The second port portion 201b is slightly offset to the downstream side (the turbocharger 60 side) from the position of the first port portion 201a so as not to overlap with the first port portion 201a in the flow direction of air. Moreover, the second port portion 201b is formed such that its axis α2 intersects the axis line α0 of the inclining part 201 at an acute angle, that is, the blow-by gas is introduced further downstream than in an orthogonal direction to the axis α0 of the inclining part 201 (see an arrow B in FIG. 6).

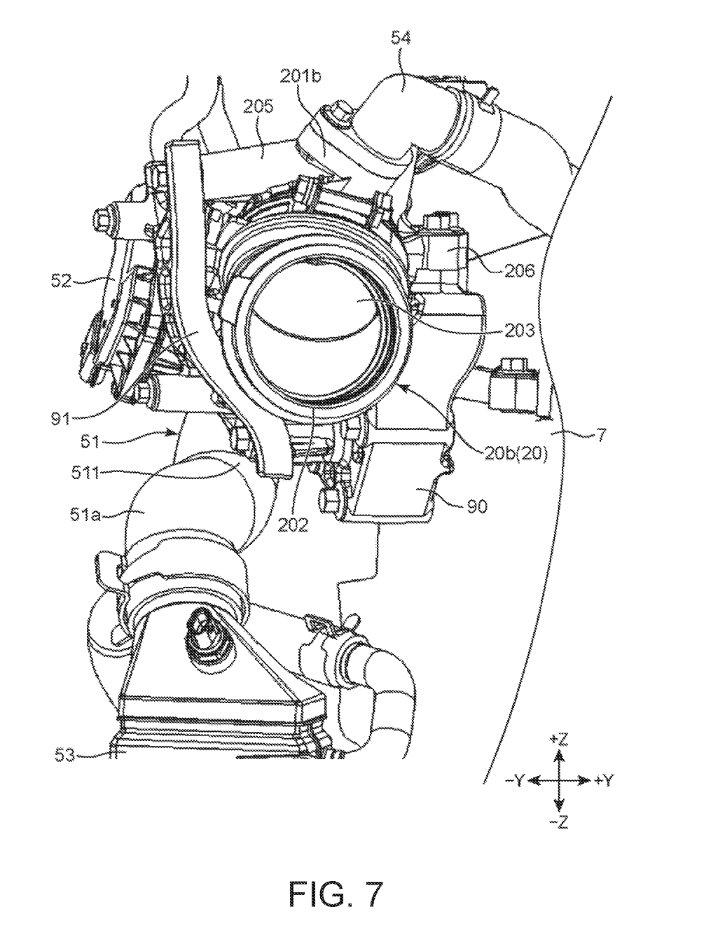

Note that as illustrated in FIG. 7, the inclining part 201 of the upstream intake passage 20a is supported by the cylinder head 7 via brackets 90 and 91 (the first bracket 90 and the second bracket 91). For example, the first bracket 90 is fixed to the −Y side surface of the cylinder head 7 with bolts, and a downstream end portion of the inclining part 201 is sandwiched between the first bracket 90 and the second bracket 91 fixed on the −Y side (outer side) of the first bracket 90 with bolt(s).

The inclining part 201 is provided with a connecting portion 205 projecting radially outward toward the −Y side from its outer circumferential surface, and a connecting portion 206 projecting to the +Y side. The connecting portion 205 is fixed to the second bracket 91 by bolt(s) and the connecting portion 206 is fixed to the first bracket 90 with bolt(s). As a result, the inclining part 201 is fixed to the brackets 90 and 91 and is supported by the cylinder head 7 via the brackets 90 and 91.

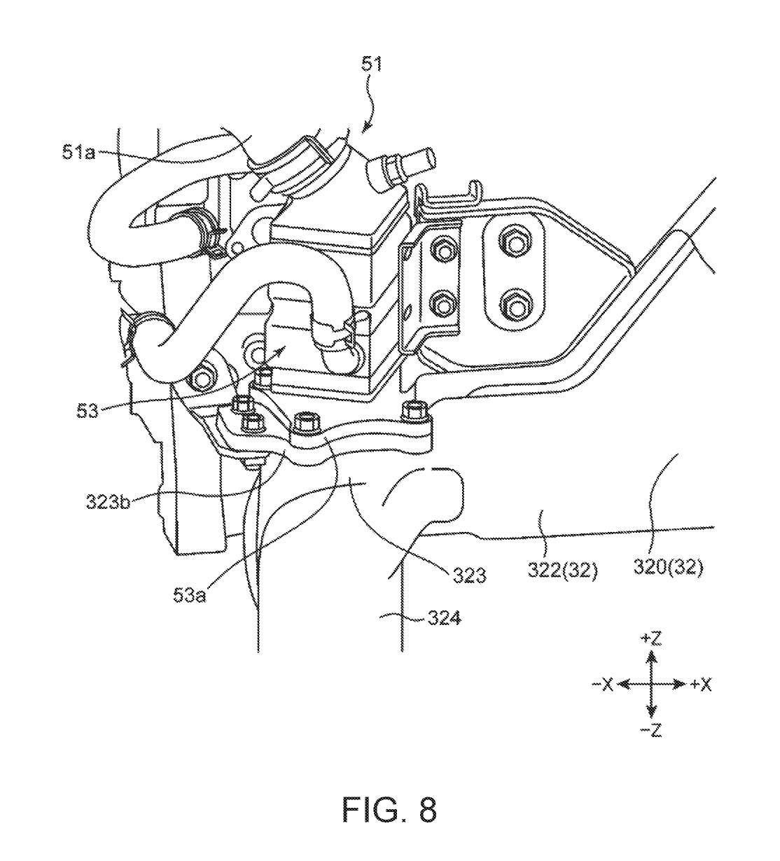

As illustrated in FIGS. 4 and 8, the upstream end part of the LP-EGR passage 51, that is, the EGR cooler 53, is connected to the +Z side surface of the branch part 323. For example, an outlet port 323a (see FIG. 9) of the exhaust gas and a flange portion 323b formed to surround the outlet port 323a are provided on the +Z side surface of the branch part 323. Further, the EGR cooler 53 is disposed on the flange portion 323b of the branch part 323, and the flange portion 323b is fastened to a flange portion 53a of the EGR cooler 53 with bolts and nuts.

The EGR cooler 53 has a substantially rectangular shape and exchanges heat with cooling water while circulating the EGR gas in its longitudinal direction. The EGR cooler 53 is fixed to the branch part 323 in a vertically placed state where the EGR gas introduced into the EGR cooler 53 from the branch part 323 through the outlet port 323a flows through the EGR cooler 53 vertically from the −Z side to the +Z side.

Note that a filter (not illustrated) is disposed in the outlet port 323a of the branch part 323 so that when soot remaining within the exhaust gas is introduced into the LP-EGR passage 51, the filter collects the soot.

As illustrated in FIG. 9, the outlet port 323a is formed at a slightly outer corner side of the curved branch part 323 (a smaller curvature side) and has an oval (or ellipse) shape extending in the flow direction of the exhaust gas. On the other hand, the EGR cooler 53 has a rectangular shape in cross section, and the EGR cooler 53 is fixed to the branch part 323 in a state where the outlet port 323a is located at a substantially center of the rectangular cross section and a longitudinal direction of the rectangular cross section coincides with a longitudinal direction of the outlet port 323a. That is, since a major portion of the exhaust gas flows at the outer corner side of the curved branch part 323, in other words, the main stream of the exhaust gas is at the outer corner side of the curved branch part 323, by forming the outlet port 323a at the slightly outer corner side of the branch part 323 which curves as described above, the EGR cooler 53 suitably takes in a required amount of exhaust gas. Further, since the outlet port 323a has the oval shape extending along the flow direction of the exhaust gas, a large amount of exhaust gas is taken into the EGR cooler 53 without causing a flow rate variation, and thus, cooling efficiency of the EGR cooler 53 is improved. Note that for the sake of convenience, the flange portion 323b is omitted in FIG. 9.

### [Operations and Effects]

In the engine 2 described above, the exhaust gas discharged from the exhaust port 14 and passed through the upstream exhaust passage 30a and the turbocharger 60 (turbine 60b) is discharged outside through the downstream exhaust passage 30b (the DOC 31, the DPF 32, the exhaust shutter valve 33, and the silencer 34). Further, a portion of the exhaust gas introduced into the downstream exhaust passage 30b is introduced into the LP-EGR passage 51 from the branch part 323 provided downstream of the DPF 32, and is recirculated to the upstream intake passage 20a through the LP-EGR passage 51.

Here, according to the intake system 4 and the exhaust system 5 of this embodiment, the LP-EGR passage 51 extends in the Z directions, the downstream end part of the LP-EGR passage 51 is connected to the −Z side surface (lower part) of the upstream intake passage 20a, and the upstream end part is connected to the +Z side surface (upper part) of the downstream exhaust passage 30b. Therefore, the condensed water generated in the LP-EGR passage 51 is swiftly returned to the downstream exhaust passage 30b while flowing along the LP-EGR passage 51.

However, this raises a concern that the condensed water generated in the upstream intake passage 20a is introduced into the LP-EGR passage 51. In this regard, according to the structure of this embodiment, the inclining part 201 is provided on the immediately upstream (−X) side of the connecting point of the upstream intake passage 20a with the turbocharger 60, and the LP-EGR passage 51 is connected to the inclining part 201. Therefore, the introduction of the condensed water into the LP-EGR passage 51 is prevented. That is, in the inclining part 201, the condensed water easily flows along the inclination, and by the air suction into the turbocharger 60, this tendency of condensed water is enhanced. Therefore, even if the condensed water is generated in the upstream intake passage 20a, it mainly moves to the turbocharger 60 side and it becomes more difficult for the condensed water to be introduced into the LP-EGR passage 51. Therefore, it is prevented that the condensed water is introduced into the LP-EGR passage 51 from the upstream intake passage 20a and adheres to the EGR valve, or the condensed water accumulates in the EGR valve 52 when the EGR valve 52 is closed, that is, the condensed water accumulates in the passage section on the +Z side of the EGR valve 52.

Note that in this embodiment, since the blow-by gas passage 54 is connected to the upstream intake passage 20a, it may be considered that the condensed water generated in the blow-by gas passage 54 is introduced into the upstream intake passage 20a together with the blow-by gas. However, in this case, similar to the example given above, the condensed water mainly moves toward the turbocharger 60 along the inclining part 201.

Especially, the blow-by gas passage 54 is connected to the +Z side surface (upper portion) of the inclining part 201 at a position downstream of the connecting position of the LP-EGR passage 51, and the blow-by gas passage 54 is connected to the inclining part 201 to introduce the blow-by gas thereinto to the downstream side. According to this structure, also in the case where the condensed water is introduced into the upstream intake passage 20a (inclining part 201) through the blow-by gas passage 54, the condensed water drops or moves to the position downstream of the connecting position with the LP-EGR passage 51 all the time. Therefore, the condensed water introduced into the upstream intake passage 20a together with the blow-by gas is rarely introduced into the LP-EGR passage 51 and accumulates at the EGR valve 52.

Further in this embodiment, the EGR valve 52 is provided in the downstream end part of the LP-EGR passage 51 and the EGR valve 52 is directly connected to the inclining part 201, which also prevents the condensed water from accumulating at the EGR valve 52. In other words, the longer the distance from the connecting position of the LP-EGR passage 51 with the inclining part 201 to the EGR valve 52 is, the space for the condensed water to accumulate on the downstream side of the EGR valve increases, which may cause accumulation of a larger amount of condensed water. However, according to this embodiment, by directly connecting the EGR valve 52 to the inclining part 201, this space is reduced as small as possible. Therefore, the EGR valve 52 is prevented from accumulating condensed water, and even if it does, the accumulation amount is small. Thus, it can be said that the accumulation of the condensed water at the EGR valve 52 is prevented.

Moreover, in this embodiment, by providing the EGR cooler 53 in the upstream end part of the LP-EGR passage 51, the EGR valve 52 and the EGR cooler 53 are separated widely from each other. Therefore, even when the condensed water is generated within the EGR gas after being cooled by passing through the EGR cooler 53, the condensed water flows along the connecting passage 51a before reaching the EGR valve 52. Especially in this embodiment, since the connecting passage 51a curves (curved portion 511) at its intermediate location, the condensed water flowing together with the EGR gas collides against the wall surface at the curved portion 511 and thus is separated from the EGR gas. That is, the wall surface at the curved portion 511 functions as a baffle plate. Therefore, it is effectively prevented that the condensed water generated in the LP-EGR passage 51 flows through the EGR valve 52 together with the EGR gas and adheres to the EGR valve 52 or accumulates at the EGR valve 52.

Note that the curved portion 511 curves without curving below the horizontal plane, i.e., has a shape in which the upstream side is located on the −Z side of (below) the downstream side thereof. Therefore, although the baffle plate is provided at the intermediate location of the connecting passage 51a, no inconvenience, such as the condensed water accumulated in the curved portion 511, occurs from this.

Thus, according to this embodiment, the accumulation of the condensed water at the EGR valve 52 of the LP-EGR passage 51 is effectively prevented. Even if it does accumulate, the accumulation amount is small. Therefore, an issue such as the condensed water accumulated in the EGR valve 52 freezes to cause a valve malfunction, is effectively prevented.

Additionally, according to this embodiment, the EGR cooler 53 of the LP-EGR passage 51 is directly connected to the branch part 323 of the downstream intake passage 20b in the vertically placed state as described above (where the EGR gas flows vertically). According to this structure, the condensed water is mainly generated at the position closest possible to the upstream exhaust passage 30a, and the condensed water swiftly flows along the EGR cooler 53 in the Z directions (to the −Z side). Therefore, the condensed water generated by the EGR cooler 53 is introduced into the downstream exhaust passage 30b as swiftly as possible. Especially, when the EGR valve 52 is closed, by the exhaust gas flowing in the guide part 324 from the DOC 31 through the branch part 323, the suction effect (ejector effect) of the condensed water inside the EGR cooler 53 is obtained. Thus, the condensed water generated in the EGR cooler 53 is swiftly introduced into the downstream exhaust passage 30b.

Note that in the above structure in which the EGR valve 52 and the EGR cooler 53 are placed at both ends of the LP-EGR passage 51 to be separated from each other, it is a concern that a relatively large amount of condensed water is generated inside the connecting passage 51a, which is introduced into the downstream exhaust passage 30b through the EGR cooler 53, and the condensed water backflows (enters into) the DPF 32. However, in this embodiment, the downstream exhaust passage 30b includes the branch part 323 connected to the outlet part 322 of the DPF 32, and the guide part 324 connected to the branch part 323 which guides the exhaust gas from the branch part 323 to the −Z side. The LP-EGR passage 51 is connected to the +Z side surface (upper portion) of the branch part 323. According to this structure, while the engine 2 operates, the exhaust gas is discharged from the outlet part 322 of the DPF 32 and flows to the guide part 324 the branch part 323. Therefore, the condensed water flows to the branch part 323 through the outlet port 323a from the EGR cooler 53 joins the flow of the exhaust gas in the branch part 323 and flows downstream while being guided to the guide part 324. Moreover, in the DPF 32, as indicated by the dashed arrow in FIG. 2, the exhaust gas flows obliquely to the downstream side from the upstream side, and as the exhaust gas further flows along the inner surface at the −Z side (inner bottom surface) of the DPF 32, it is led out from the tubular-shaped outlet part 322 extending in the X directions. Thus, a relatively strong flow of exhaust gas is formed in the portion from the outlet part 322 over the branch part 323, and the condensed water does not easily backflow from the LP-EGR passage 51 to the DPF 32. As a result, an issue such as the condensed water backflowing from the LP-EGR passage 51 to the DPF 32, which causes corrosion of the DPF 32, is effectively prevented.

Note that with the structure of this embodiment in which the EGR valve 52 of the LP-EGR passage 51 is directly connected to the inclining part 201 of the upstream intake passage 20a, the weights of the EGR valve 52 and the connecting passage 51a concentrate in the inclining part 201, and therefore, a sufficient support rigidity of the upstream intake passage 20a needs to be secured. In this regard, according to this embodiment, since the inclining part 201 is fixed to the cylinder head 7 via the bracket 90 and 91, the sufficient support rigidity is secured. Therefore, although it is structured such that the EGR valve 52 and the connecting passage 51a are suspended from the upstream intake passage 20a (inclining part 201), the upstream intake passage 20a is stably provided to the engine body 3.

### [Modifications]

(1) Although in the above embodiment the EGR valve 52 is provided to the downstream end part of the LP-EGR passage 51, it may be provided to a further upstream position. Further, although the EGR cooler 53 is provided in the upstream end part of the LP-EGR passage 51, it may be provided at a further downstream position. Note that as in the above embodiment, according to the structure in which the EGR valve 52 and the EGR cooler 53 are placed at both ends of the LP-EGR passage 51 to be separated from each other, the accumulation of the condensed water in the passage section on the +Z side of the EGR valve 52 is prevented, the section between the EGR valve 52 and the EGR cooler 53 is used to effectively let the condensed water flow down, and the condensed water generated inside the EGR cooler 53 is swiftly introduced into the downstream exhaust passage 30b. Therefore, in effectively preventing the condensed water from adhering to or accumulating at the EGR valve 52, the structure as in the above embodiment is suitable.

(2) Although in the above embodiment the inclining part 201 is provided in the part of the upstream intake passage 20a immediately upstream of the turbocharger 60, and the LP-EGR passage 51 and the blow-by gas passage 54 are connected to the inclining part 201, it is not limited to this. For example, the part of the upstream intake passage 20a immediately upstream of the turbocharger 60 may be arranged horizontally and this horizontal part may be connected to the LP-EGR passage 51 and the blow-by gas passage 54.

(3) Although in the above embodiment the blow-by gas passage 54 is connected to the +Z side of the upstream intake passage 20a (inclining part 201), and the LP-EGR passage 51 is connected to the −Z side of the same, it is not limited to this. A structure in which at least one of the blow-by gas passage and the EGR passage is connected in one of the Y sides (horizontally), or a structure in which both of the blow-by gas passage and the EGR passage are connected from one of the Z sides may be adopted.

(4) Although in the above embodiment the EGR cooler 53 is arranged so that the EGR gas flows vertically (Z directions), it is not limited to this, e.g., the EGR gas may flow horizontally. Note that to swiftly introduce the condensed water generated inside the EGR cooler 53 toward the downstream exhaust passage 30b, the configuration as in the above embodiment is suitable.

(5) Although in the above embodiment the multi-cylinder diesel engine is adopted as one example of the engine body 3, it is not limited to this. For example, the number of cylinders may be one, and the type of engine may be a gasoline engine. Moreover, the shape of the engine is also not limited to an inline type, and instead, a V-type, a W-type, or a horizontally opposed shape may be adopted.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Vehicle
2 Engine
3 Engine Body
4 Intake System
5 Exhaust System
20 Intake Passage
20a Upstream Intake Passage
20b Downstream Intake Passage
30 Exhaust Passage
30a Upstream Exhaust Passage
30b Downstream Exhaust Passage
51 LP-EGR Passage (EGR Passage)
51a Connecting Passage
52 EGR Valve
53 EGR Cooler
54 Blow-by Gas Passage
60 Turbocharger
60a Compressor
60b Turbine
201 Inclining Part
511 Curved Portion

What is claimed is:

1. An intake and exhaust system of an engine mounted on a vehicle, comprising:
an exhaust passage;
an intake passage disposed above the exhaust passage in up-and-down directions of the vehicle; and
an exhaust gas recirculation (EGR) passage extending in the up-and-down directions and communicating the exhaust passage to the intake passage, the EGR passage including:
an EGR cooler;
an EGR valve disposed downstream of the EGR cooler in a flow direction of EGR gas; and
a connecting passage, disposed between the EGR cooler and the EGR valve, that connects the EGR cooler to the EGR valve in a separated state from each other in the flow direction.

2. The system of claim 1, wherein the connecting passage extends upwardly from the EGR cooler and curves at an intermediate location without curving below a horizontal plane.

3. The system of claim 1, wherein the EGR valve is provided in a downstream end part of the EGR passage in the flow direction of the EGR gas.

4. The system of claim 1, wherein the EGR cooler is provided in an upstream end part of the EGR passage in the flow direction of the EGR gas and is directly connected to the exhaust passage.

5. The system of claim 1, wherein the EGR cooler is arranged so that the EGR gas flows upwardly.
